(19) United States
(12) Patent Application Publication
(10) Pub. No.: US 2007/0259229 A1
(43) Pub. Date: Nov. 8, 2007

(54) FUEL CELL ACTIVATION METHOD AND THE DEVICE THEREOF

(76) Inventors: CHUN-CHIN TUNG, Chu Fei (TW); Yung-Lieh Chien, Chu Pei (TW)

Correspondence Address: G. LINK CO., LTD, 3550 BELL ROAD, MINOOKA, IL, 60447, US

(21) Appl. No.: 11/740,921

(22) Filed: Apr. 27, 2007

(30) Foreign Application Priority Data
May 4, 2006 (TW) 095115845

(51) Int. Cl. H01M 8/04; C23F 11/06

(52) U.S. Cl. 429/22; 422/13

(57) ABSTRACT

The present invention discloses a fuel cell activation method having an operational procedure formed by an electrical power generator, a fuel processing unit, a fan unit and a control unit. The operational procedure includes the step of the control unit selects a startup mode; the step of the control unit starts up the fuel processing unit such that liquid fuel is injected into an anode of the electrical power generator for T1 time; the step of the control unit selects to start up a specific electrical load of the internal load power-supply circuit such that the electrical power generator outputs electrical power to the specific electrical load of the internal load power-supply circuit based on the power output form of a section near the maximum output power of the output voltage-output power curve and the control unit selects to start up the fan unit for T2 time; and the step of the control unit selects to turn off the fuel processing unit and the fan unit for T3 time. Additionally, based on the startup mode selected the control unit decides whether the step of starting up the fuel processing unit, the step of selecting a specific electrical load, the step of selecting to start up the fan unit and the step of selecting to turn off the fuel processing unit and the fan unit being sequentially and repeatedly performed, and the step of the control unit decides the frequency of repeating. Moreover, the control unit decides whether the electrical power generator completely activates the startup procedure, wherein T1 time, T2 time and T3 time are respectively selected either based on the properties of a membrane electrode assembly (MEA) of the electrical power generator or based on experimentally derived preferable parameters.

### FIELD OF THE INVENTION

The present invention relates to a fuel cell activation method and the device thereof, particularly to a fuel cell activation method wherein operational parameters of a fuel processing unit are selected either based on the properties of a membrane electrode assembly (MEA) of an electrical power generator or based on experimentally derived preferable parameters in order to activate the electrical power generator of the fuel cell.

### BACKGROUND OF THE INVENTION

If conventional fuel cells have not been used for a long time, their membrane electrode assembly (MEA) becomes less humid for activation. Therefore, for conventional fuel cells, their MEAs must be humidified and their electrochemical reactions must be activated before the fuel cells achieve normal electrochemical reaction efficiency and rated output power. Given that the temperature of a fuel cell also affects its efficiency, the fuel cell warming mechanism must be provided to achieve electrochemical reaction efficiency.

To overcome the drawbacks of conventional fuel cells, the present invention provides a fuel cell activation method and the device thereof to activate the MEA of the fuel cell.

### SUMMARY OF THE INVENTION

Accordingly, an objective of the present invention is to provide a fuel cell activation method and the device thereof, in order to provide an activation procedure for the fuel cell's MEA.

Alternatively, another objective of the invention is to provide a fuel cell activation method and the device thereof, such that operational parameters of a fuel processing unit are selected either based on the properties of a membrane electrode assembly (MEA) of an electrical power generator or based on experimentally derived preferable parameters in order to activate the electrical power generator.

Alternatively, another objective of the invention is to provide a fuel cell activation method and the device thereof, wherein the fuel cell is activated by several fuel cell startup modes, including: a first-time startup mode, a “SLEEP” startup mode (for inactive fuel cells), an “IDLE” startup mode (for recently active fuel cells), a fast startup mode, an energy-saving startup mode and other fuel cell startup modes.

Alternatively, another objective of the invention is to provide a fuel cell activation method and the device thereof, wherein the fuel cell is activated by an internal load power-supply circuit or a constant current load or a constant resistance load in order to warm the fuel cell by the thermal energy generated by the constant resistance load during activation.

To achieve the above-mentioned objectives, the present invention discloses a fuel cell activation method having an operational procedure formed by an electrical power generator, a fuel processing unit, a fan unit and a control unit. The operational procedure includes (1) the step of the control unit selects a startup mode; (2) the step of the control unit starts up the fuel processing unit, such that liquid fuel at a higher operating concentration (generally 1.5 to 2 times that of normal operating concentration) is injected into an anode of the electrical power generator for T1 time; (3) the step of the control unit selects to start up a specific electrical load of the internal load power-supply circuit, such that the electrical power generator outputs electrical power to the specific electrical load of the internal load power-supply circuit based on the power output type of a section near the maximum output power of the output voltage-output power curve and the control unit selects to start up the fan unit for T2 time; (4) the step of the control unit selects to turn off the fuel processing unit and the fan unit for T3 time; (5) based on the startup mode selected, the step of the control unit decides whether the step of starting up the fuel processing unit, the step of selecting a specific electrical load, the step of selecting to start up the fan unit and the step of selecting to turn off the fuel processing unit and the fan unit being sequentially and repeatedly performed and decides the frequency of repeating; and (6) the step of the control unit decides whether the electrical power generator has completely activated the startup procedure, wherein T1 time, T2 time and T3 time are selected either based on the properties of a membrane electrode assembly (MEA) of an electrical power generator or based on experimentally derived preferable parameters.

According to a preferred embodiment of the present invention, the control unit selects a constant voltage load or a constant current load or a constant resistance load of the internal load power-supply circuit, wherein the control unit selects the constant resistance load as the specific electrical load of the internal load power-supply circuit. Additionally, the constant resistance load includes an electronic switch and a resistor, wherein the constant resistance load is electrically coupled to the electronic switch, which is electrically coupled to the electrical power generator. Moreover, the control unit selects either an “ON” state or an “OFF” state of the electronic switch in order to decide whether the constant resistance load is electrically coupled to the electrical power generator or not.

According to another preferred embodiment of the present invention, the resistor for the constant resistance load is installed either on the electrical power generator or on the fuel processing unit to warm the electrical power generator and fuel during the fuel cell activation, and to speed up the activation procedure of the fuel cell.

The present invention may be better understood, and its numerous objects, features, and advantages made apparent to those skilled in the art by referencing the following embodiments and the accompanying drawings.

### BRIEF DESCRIPTION OF THE DRAWINGS

The present invention can be more fully understood by reading the subsequent detailed description and examples with references made to the accompanying drawings, wherein:

FIG. 1 is an illustrative view of the relationship among components disclosed in the fuel cell activation device for the present invention;

FIG. 2 is an illustrative view of the output voltage-output power curve disclosed in the MEA of the fuel cell activation device for the present invention;

FIG. 3 is a perspective view and a cut-away view of local components disclosed in an embodiment of a fuel cell activation device shown in FIG. 1 of the present invention.

FIG. 4 is a view illustrating the steps in the fuel cell activation method of the present invention; and

FIG. 5 is an illustrative view of the relationship among local components disclosed in another embodiment of the fuel cell activation device for the present invention.

### DETAILED DESCRIPTION OF THE INVENTION

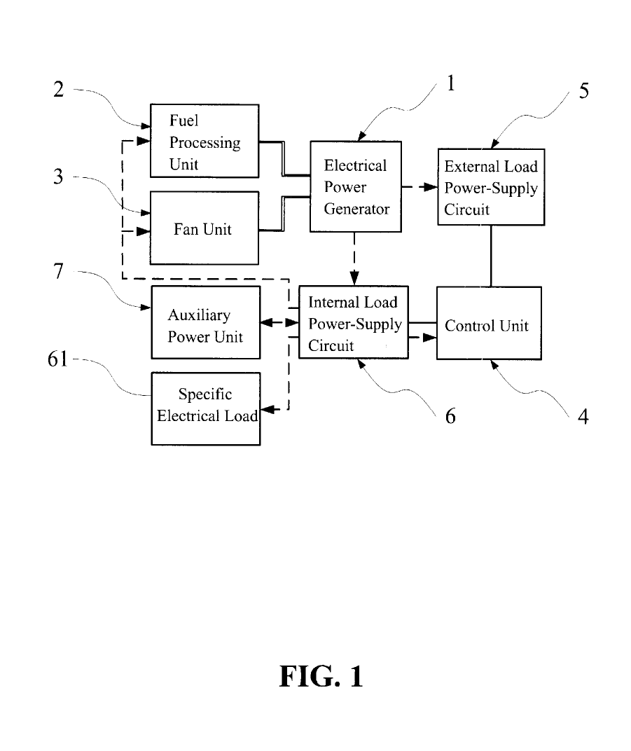

Referring to FIG. 1, the present invention discloses a fuel cell activation device including an electrical power generator (1), a fuel processing unit (2), a fan unit (3), a control unit (4), an external load power-supply circuit (5), an internal load power-supply circuit (6) and an auxiliary power unit [APU] (7). The electrical power generator (1) undergoes electrochemical reactions through a catalyst-containing membrane electrode assembly (MEA) by combining hydrogen-rich fuels and oxygen fuels, thereby converting chemical energy into electrical energy. Controlled by the control unit (4), the fuel processing unit (2) generates corresponding operations to supply anode fuel required for electrochemical reactions of the electrical power generator (1) and to cause fuel to circulate around an anode of the electrical power generator (1). The fan unit (3), controlled by the control unit (4), generates corresponding operations to supply gaseous oxygen fuel required for electrochemical reactions of the electrical power generator (1) and to cause heat dissipation of the electrical power generator (1). The control unit (4) includes a logical judgment means and an information input/output means, wherein the logical judgment means generates control information corresponding to the operations of respective devices, while the information input/output means is electrically coupled to respective devices and transmits the control information. The external load power-supply circuit (5) capable of voltage conversion and electrical power transmission is electrically coupled to the electrical power generator (1) in order to convert the electrical power generated by the electrical power generator (1) into an electrical power output at a specific voltage, which is supplied to an external electronic device by transmitting the external load power-supply circuit (5). The internal load power-supply circuit (6) includes a specific electrical load (61) and a power transmission means for consuming the electrical power generated by the electrical power generator (1) during fuel cell activation and for transmitting the electrical power generated by the electrical power generator (1) to the fuel processing unit (2), the fan unit (3), the control unit (4) and the auxiliary power unit [APU] (7) in order to supply the electrical power required for the operations of these devices. The APU (7) is a secondary battery for supplying electrical power required for a plurality of active components. For example, during the fuel cell activation and startup procedure, electrical power required for the fuel processing unit (2), the fan unit (3) and the control unit (4) is provided by the APU (7), until the electrical power generator (1) starts the normal operational procedure, wherein electrical power required for the active components is supplied by the electrical power generator (1), which is capable of charging the APU (7).

The external load power-supply circuit (5) and the internal load power-supply circuit (6) are controlled by the control unit (4), such that the external load power-supply circuit (5) either outputs or does not output electrical power, and the control unit (4) either turns on or turns off the specific electrical load (61) of the internal load power-supply circuit (6). During fuel cell activation, the control unit (4) turns on the specific electrical load (61) of the internal load power-supply circuit (6), such that electrical power generated by the electrical power generator (1) is output to the specific electrical load (61) of the internal load power-supply circuit (6). After completely activating the fuel cell, the control unit (4) turns off the specific electrical load (61) of the internal load power-supply circuit (6), such that the electrical power generator (1) stops outputting electrical power to the specific electrical load (61) of the internal load power-supply circuit (6).

The specific electrical load (61) of the internal load power-supply circuit (6) selects a constant voltage load or a constant current load or a constant resistance load in order to activate a proton exchange membrane of the electrical power generator (1) during fuel cell activation.

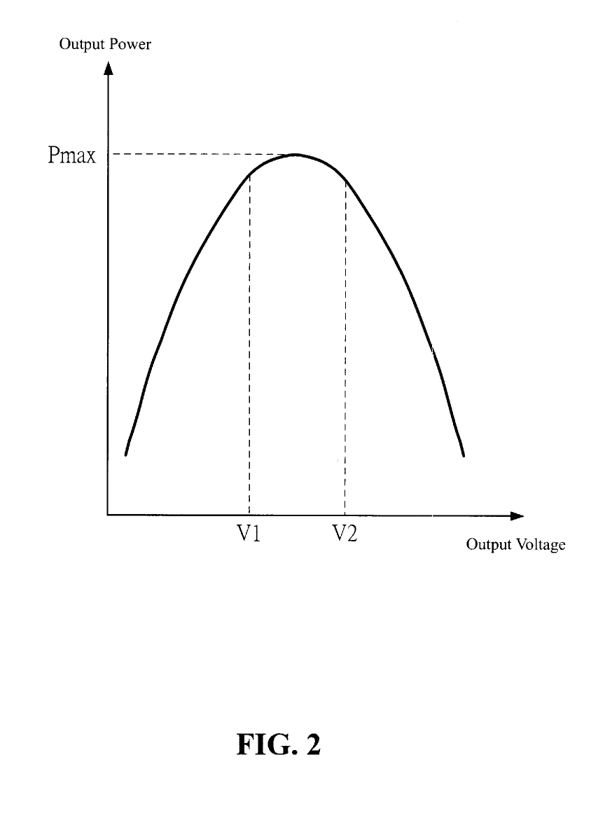

Referring to a preferred embodiment shown in FIG. 2, the specific electrical load (61) of the internal load power-supply circuit (6) is a constant voltage load based on the output voltage-output power curve of the MEA of the fuel cell. For example, according to the output voltage-output power curve of the electrical power generator (1), the section covered by the maximum output power (Pmax) corresponds to the section from the output voltage (V1) to the output voltage (V2), and the input constant voltage of the internal load power-supply circuit (6) selects either the output voltage (V1) or the output voltage (V2). Additionally, given the specific correspondence between the output voltage and the output current of the fuel cell, the output current control generated by the fuel cell is equivalent to the output voltage control. Consequently, the internal load power-supply circuit (6) inputs constant voltage with respect to the output voltage-output power curve of the internal load power-supply circuit (6), possibly based on the output current-output power curve of the electrical power generator (1). The constant voltage load of the internal load power-supply circuit (6) can be replaced by the constant current load.

The section from the output voltage (V1) to the output voltage (V2) is determined by the output voltage-output power curve of the fuel cell, whereas the output voltage-output power curve is determined by the MEA of the fuel cell. Taking Dupont's Nafion membrane as an embodiment, the constant output voltage is 0.2 V for each MEA in order to effectively activate the fuel cell with no damages made to the MEA.

The control information generated by the control unit (4) is provided by the external electronic device, which is a personal computer, a notebook, a PDA or other electronic devices such as a information processing device.

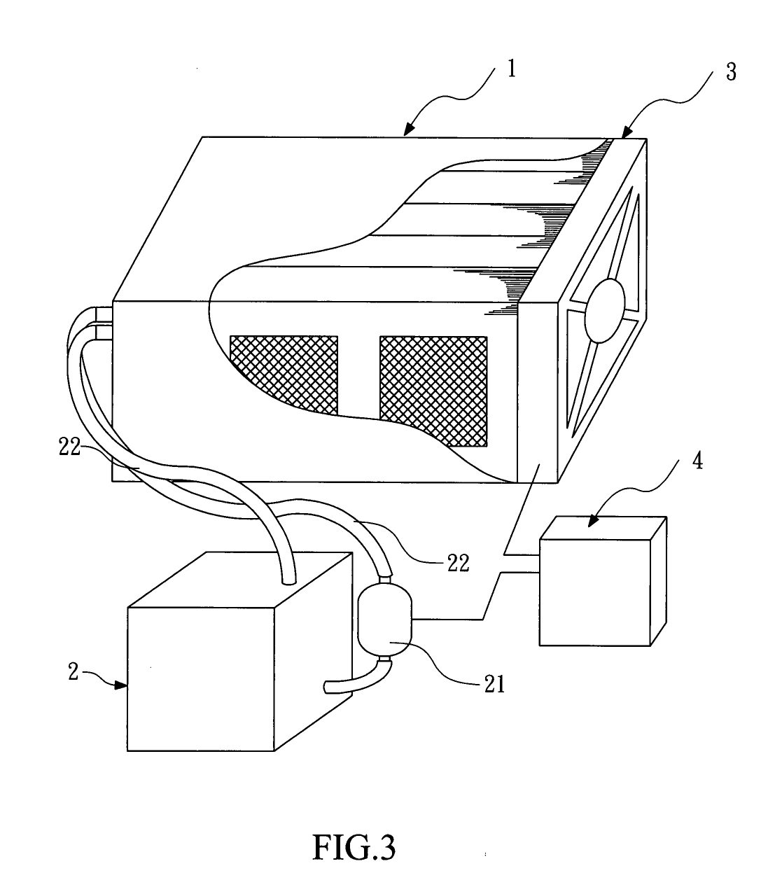

Referring to FIG. 3, the electrical power generator (1) is a direct methanol fuel cell (DMFC), which is made of a substrate structure. The fuel processing unit (2), which stores the fuel required for electrochemical reactions of the electrical power generator (1) as well as reaction residuals, further includes a pump (21) and a plurality of microchannels (22). The microchannels (22) communicate with the electrical power generator (1) and the pipeline structure of the fuel processing unit (2), whereas the pump (21) is a microfluidic driving device that drives fluid inside the microchannels (22). The fan unit (3) is primarily a fan device, which assists convection of air from the inside and the outside of the electrical power generator (1) to supply fresh air to the oxygen fuel required for the cathode of the electrical power generator (1), controls the internal temperature of the electrical power generator (1). The control unit (4) is formed by a chip and circuit means, including a logical judgment means and an information input/output means, in order to control the operations and the procedural control of the pump (21) of the fuel processing unit (2) and the fan unit (3). The control unit (4) further includes a operational recording means of the fuel cell for recording the operational status of the electrical power generator (1). The operational status includes the time information indicative the most recent operations of the electrical power generator (1).

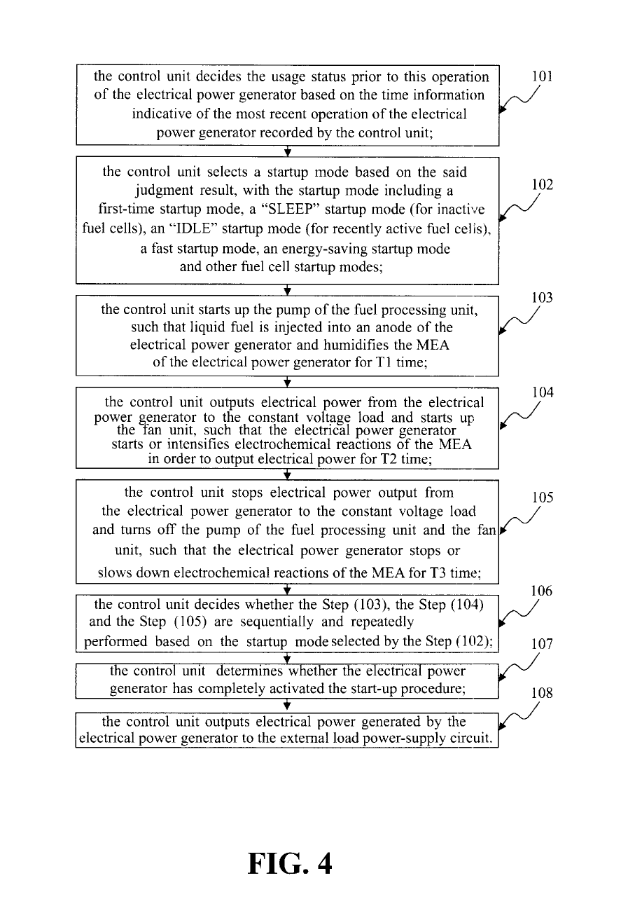

Referring to FIGS. 4, 1 & 2, the fuel cell activation method of the present invention starts up the initiation procedure of the electrical power generator (1) through the control unit (4). The initiation procedure includes: Step (101), the control unit (4) decides the usage status prior to this operation of the electrical power generator (1) based on the time information indicative of the most recent operations of the electrical power generator (1) recorded by the control unit (4); Step (102), the control unit (4) selects a startup mode based on the said judgment result, with the startup mode including a first-time startup mode, a “SLEEP” startup mode (for inactive fuel cells), an “IDLE” startup mode (for recently active fuel cells), a fast startup mode, an energy-saving startup mode and other fuel cell startup modes, each will be described later; Step (103), the control unit (4) starts up the pump (21) of the fuel processing unit (2), such that liquid fuel is injected into an anode of the electrical power generator (1) and humidizes the MEA of the electrical power generator (1) for T1 time; Step (104), the control unit (4) outputs electrical power from the electrical power generator (1) to the internal load power-supply circuit (6) and starts up the fan unit (3), such that the electrical power generator (1) starts or intensifies electrochemical reactions of the MEA in order to output electrical power for T2 time; Step (105), the control unit (4) stops electrical power output from the electrical power generator (1) to the internal load power-supply circuit (6) and turns off the pump (21) of the fuel processing unit (2) and the fan unit (3), such that the electrical power generator (1) stops or slows down electrochemical reactions of the MEA for T3 time; Step (106), the control unit (4) decids whether the Step (103), the Step (104) and the Step (105) be sequentially and repeatedly performed based on the startup mode selected by the Step (102); Step (107), the control unit (4) determines whether the electrical power generator (1) has completely activated the start-up procedure; and Step (108), the control unit (4) outputs electrical power generated by the electrical power generator (1) to the external load power-supply circuit (5).

Dupont's Nafion membrane is usually at a normal operating concentration of 10%. During the initiation procedure of the electrical power generator (1), fuel at a higher concentration is injected into the electrical power generator (1), and this concentration can be increased to 1.5 to 2 times that of normal operating concentration.

T1, T2 and T3 are determined respectively for the Step (103), the Step (104) and the Step (105) based on either the MEA properties of an electrical power generator (1) or empirically derived preferable parameters.

In Step (107), the control unit (4) determines whether the electrical power generator (1) has completely activated the startup procedure based on whether electrical power output by the electrical power generator (1) to the internal load power-supply circuit (6) reaches the default power range. The power range is determined either by the power corresponding to the constant voltage of the internal load power-supply circuit (6) in the output voltage-output power curve of the fuel cell or by the impedance detected by the electrical power generator (1) or by the MEA, in order to determine whether the electrical power generator (1) has completely activated the startup procedure.

The fuel cell's startup mode is determined by the time interval between the fuel cell startup time and the time since last use. First, the first-time startup mode refers to the state in which the control unit (4) of the electrical power generator (1) has no past usage record after the electrical power generator (1) was fabricated or after the user obtained the electrical power generator (1). Consequently, considering the unsatisfactory humid environment of the MEA of the fuel cell, the control unit (4) selects the first-time startup mode during first-time startup, such that Step (103), Step (104) and Step (105) are repeated more, until the control unit (4) determines that the electrical power generator (1) has completely activated the startup procedure. Second, the “SLEEP” startup mode (for inactive fuel cells) refers to the state in which the electrical power generator (1) is used at least several days from the time it was last used. Consequently, considering the unsatisfactory humid environment of the MEA of the fuel cell, the control unit (4) selects the “SLEEP” startup mode (for inactive fuel cells), such that Step (103), Step (104) and Step (105) in this mode are repeated less than that of the first-time startup mode, and the control unit (4) determines that the electrical power generator (1) has completely activated the startup procedure. Third, the “IDLE” startup mode (for recently active fuel cells) refers to the state in which the electrical power generator (1) is used at least several hours or minutes from the time it was last used. Consequently, considering the less unsatisfactory humid environment of the MEA of the fuel cell, the control unit (4) selects the “IDLE” startup mode (for recently active fuel cells), such that Step (103), Step (104) and Step (105) are operated once or are repeated for a few times, and the control unit (4) determines that the electrical power generator (1) has completely activated the startup procedure. Fourth, the fast startup mode refers to the state in which the electrical power generator (1) considers a faster startup for the fuel cell's MEA, such that the control unit (4) selects fewer repetitions or no repetition for Step (103), Step (104) and Step (105), and the control unit (4) determines that the electrical power generator (1) has completely activated the startup procedure. The control unit (4) lowers the output power restrictions of the fuel cell and increases the reference value of the MEA impedance, in order to activate the startup procedure of the fuel cell within a shorter time. Fifth, the energy-saving startup model refers to the state in which the electrical power generator (1) considers more energy-saving fuel for starting up the fuel cell's MEA. Consequently, the control unit (4) selects fewer repetitions or no repetition for Step (103), Step (104) and Step (105), and the control unit (4) determines that the electrical power generator (1) has completely activated the startup procedure. The control unit (4) lowers the output power restrictions of the fuel cell, increases the reference value of the MEA's impedance and selects an output voltage at a higher operational efficiency of the fuel cell, in order to activate the startup procedure of the fuel cell with less fuel.

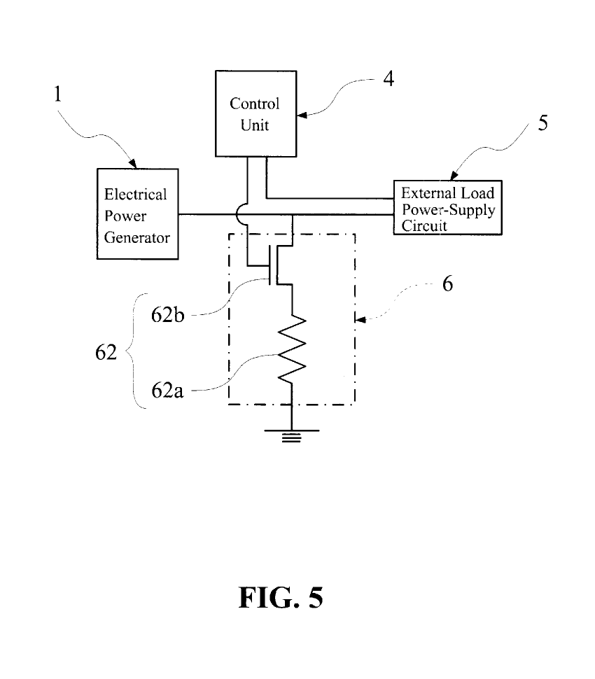

Referring to the embodiment in FIG. 5, the internal load power-supply circuit (6) further includes a constant resistance load (62), which is an electrical load at constant resistance. The electrical power generator (1) is electrically coupled to the constant resistance load (62) for inputting electrical power generated by the electrical power generator (1) to the constant resistance load (62). The control unit (4) is electrically coupled to the constant resistance load (62) and the external load power-supply circuit (5), such that the control unit (4) controls either the “ON” or the “OFF” of the constant resistance load (62) and the external load power-supply circuit (5).

A preferred embodiment of the constant resistance load (62) of the internal load power-supply circuit (6) is formed by series connecting a resistor (62a) to an electronic switch (62b), such that the resistor (62a) is a low-resistivity resistor and the electronic switch (62b) is an n-channel MOS device. An end of the resistor (62a) is electrically, series connected to a source of the electronic switch (62b), while another end of the resistor (62a) is connected to the ground. Then a gate of the electronic switch (62b) is electrically coupled to the control unit (4), while a drain of the electronic switch (62b) is electrically coupled to the electrical power generator (1). Also, the power output end of the electrical power generator (1) is simultaneously, electrically coupled to the drain of the resistor (62a) and the external load power-supply circuit (5). Consequently, when activating the fuel cell, the control unit (4) turns on the electronic switch (62b) and turns off the external load power-supply circuit (5), such that the electrical power generator (1) outputs electrical power to the constant resistance load (62) and forms a power output mode at constant electrical load. Until the logical judgment means of the control unit (4) generates the control information indicative of completing activation for the electrical power generator (1), the information input/output means of the control unit (4) outputs the control information to the electronic switch (62b) of the constant resistance load (62), thereby turning off the electronic switch (62b) and stopping electrical power output from the electrical power generator (1) to the constant resistance load (62).

The resistor (62a) of the constant resistance load (62) is installed either on the electrical power generator (1) or on the fuel processing unit (2), such that when activating the fuel cell, it is possible to speed up increasing the operating temperature of the electrical power generator (1) by means of thermal energy generated by the resistors (62a). The constant resistance load (62) preferably includes a plurality of the resistors (62a), which are either electrically, series connected to or electrically, parallel connected to each other and are respectively disposed near the MEA of the electrical power generator (1) or on the microchannels (22) of the fuel processing unit (2) or on the fan unit (3) of the fuel processing unit (2). Consequently, the electrical power generator (1) can be warmed directly by thermal energy generated by the resistors (62a) near the MEA of the electrical power generator (1) or indirectly by heating the fuel of the microchannels (22) through the action of the resistors (62a) in the microchannels (22) of the fuel processing unit (2) during fuel cell activation. Also, the resistors (62a) in the fan unit (3) of the fuel processing unit (2) warm the air generated by the fan unit (3), directly increasing the temperature of the electrical power generator (1).

When activating the fuel cell, the output voltage control of the electrical power generator (1) is determined by the output voltage-output power curve of the MEA in the fuel cell. Then the control unit (4) controls voltage between the output voltage (V1) to the output voltage (V2) near the maximum output power (Pmax) selected by the electrical power generator (1), until the fuel cell is completely activated. Consequently, the control unit (4) outputs electrical power from the electrical power generator (1) to the internal load power-supply circuit (6), while the control unit (4) turns on the electronic switch (62b) for the constant resistance load (62) of the internal load power-supply circuit (6), such that the electrical power generator (1) outputs electrical power to the resistors (62a) to activate the fuel cell, until the control unit (4) determines that the electrical power generator (1) has completely been activated.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fuel cell activation method, comprising the steps:
providing a fuel cell, further comprising an electrical power generator, a fuel processing unit, a fan unit, a control unit, an external load power-supply circuit and an internal load power-supply circuit;
the control unit selecting a startup mode;
the control unit starting up the fuel processing unit such that liquid fuel is injected into an anode of the electrical power generator for T1 time;
the control unit selecting to start up a specific electrical load of the internal load power-supply circuit, such that the electrical power generator outputs electrical power to the specific electrical load of the internal load power-supply circuit based on the power output form of a section near the maximum output power of the output voltage-output power curve, and the control unit selects to start up the fan unit for T2 time;
the control unit selecting to turn off the fuel processing unit and the fan unit for T3 time;
based on the startup mode selected, the control unit deciding whether the step of starting up the fuel processing unit, the step of selecting a specific electrical load, the step of starting up the fan unit and the step of selecting to turn off the fuel processing unit and the fan unit being sequentially and repeatedly performed, and deciding the frequency of repeating; and
the control unit deciding whether the electrical power generator completely activates the startup procedure;
wherein T1 time, T2 time and T3 time are selected either based on the properties of a membrane electrode assembly (MEA) of an electrical power generator or based on experimentally derived preferable parameters.

2. The fuel cell activation method as claimed in claim 1, wherein the control unit selects a constant voltage load or a constant current load or a constant resistance load as the specific electrical load of the internal load power-supply circuit.

3. The fuel cell activation method as claimed in claim 2, wherein the electrical power generator comprises a membrane electrode assembly (MEA), which is a Dupont's Nafion membrane.

4. The fuel cell activation method as claimed in claim 3, wherein liquid fuel at a higher operating concentration is injected into the anode of the electrical power generator.

5. The fuel cell activation method as claimed in claim 4, wherein the operating concentration of liquid fuel injecting into the anode of the electrical power generator is increased to 1.5 to 2 times that of the normal operating concentration.

6. The fuel cell activation method as claimed in claim 3, wherein the control unit selects a constant voltage load, such that the electrical power generator outputs a constant output voltage equivalent to each 0.2 V for each MEA.

7. The fuel cell activation method as claimed in claim 2, wherein the control unit selects a constant resistance load as the specific electrical load of the internal load power-supply circuit, and the constant resistance load comprises an electronic switch and a resistor;
wherein the constant resistance load is electrically coupled to the electronic switch, which is electrically coupled to the electrical power generator, and the control unit selects either an “ON” state or an “OFF” state of the electronic switch in order to decide whether the constant resistance load is electrically coupled to the electrical power generator or not.

8. The fuel cell activation method as claimed in claim 7, wherein the resistor of the constant resistance load is installed either on the electrical power generator or on the fuel processing unit.

9. The fuel cell activation method as claimed in claim 7, wherein the control unit selects the constant resistance load as the specific electrical load of the internal load power-supply circuit, and the constant resistance load further comprising a plurality of the constant resistance loads;
wherein the control unit turns on either one or a plurality of electronic switches of the constant resistance load.

10. The fuel cell activation method as claimed in claim 9, wherein the resistors of the constant resistance load are respectively disposed either on the electrical power generator or on the fuel processing unit.

11. The fuel cell activation method as claimed in claim 1, wherein the fuel processing unit further comprising a pump and a plurality of microchannels; the microchannels communicate with the electrical power generator and the pipeline structure of the fuel processing unit, while the pump is a microfluidic driving device that drives fluid inside the microchannels; the fan unit further comprising a fan device to assist convection of air from the inside and the outside of the electrical power generator; wherein
the step of the control unit starting up the fuel processing unit refers to the step in which the control unit starts up the pump of the fuel processing unit;
the step of the control unit selecting to start up the fan unit refers to the step in which the control unit starts up the fan device; and
the step of the control unit selecting to turn off the fuel processing unit and the fan unit refers to the step in which the control unit turns off the pump of the fuel processing unit and the fan device.

12. The fuel cell activation method as claimed in claim 11, wherein the control unit is formed by a chip and circuit means, including a logical judgment means and an information input/output means, in order to control the operations and the procedural control of the pump of the fuel processing unit and the fan unit; the control unit further comprises a operational recording means of the fuel cell for recording the operational status of the electrical power generator; the operational status having time information indicative of the most recent operations of the electrical power generator.

13. The fuel cell activation method as claimed in claim 12, wherein the electrical power generator is a direct methanol fuel cell, which is made of a substrate structure.

14. The fuel cell activation method as claimed in claim 2, wherein the control unit selects a constant resistance load as the specific electrical load of the internal load power-supply circuit and the constant resistance load comprises an electronic switch and a resistor;
wherein the constant resistance load is electrically coupled to the electronic switch, which is electrically coupled to the electrical power generator, and the control unit selects either an “ON” state or an “OFF” state of the electronic switch to decide whether the constant resistance load is electrically coupled to the electrical power generator or not.

15. The fuel cell activation method as claimed in claim 11, wherein the resistor of the constant resistance load is installed either on the electrical power generator or on the fuel processing unit.

16. The fuel cell activation method as claimed in claim 11, wherein the control unit selects a constant resistance load as the specific electrical load of the internal load power-supply circuit, and the constant resistance load further comprising a plurality of the constant resistance loads;
wherein the control unit turns on either one or a plurality of electronic switches for the plurality of the constant resistance loads.

17. The fuel cell activation method as claimed in claim 16, wherein the resistors of the constant resistance loads are respectively disposed either on the electrical power generator or on the fuel processing unit.

18. The fuel cell activation method as claimed in claim 1, wherein the control unit outputs electrical power generated by the electrical power generator to the external load power-supply circuit, when the control unit determines whether the electrical power generator has completely activated the startup procedure.

19. The fuel cell activation method as claimed in claim 1, wherein the control unit comprises an information input/output means, which is electrically coupled to the control unit and an external electrical load for communicating information between the control unit and the external electrical load via the information input/output means.

20. The fuel cell activation method as claimed in claim 19, wherein the external electrical load is a personal computer or a notebook or a PDA or other information processing device.

21. The fuel cell activation method as claimed in claim 20, wherein the control information of the fuel processing unit and the fan unit generated by the control unit is supplied by the external electrical load.

22. The fuel cell activation method as claimed in claim 1, wherein the control unit keeps past usage records of the electrical power generator and selects a fuel cell startup mode based on the past usage record of the electrical power generator.

23. The fuel cell activation method as claimed in claim 1, wherein the control unit comprises an information input/output means to select either a fast startup mode or the an energy-saving mode of the fuel cell;
wherein the fast startup mode refers to the mode wherein the control unit selects the step of starting up the fuel processing unit, the step of selecting a specific electrical load, the step of selecting electrical power output from the electrical power generator to the specific electrical load, the step of starting up the fan unit and the step of turning off the fuel processing unit and the fan unit being sequentially repeated for a smaller number of times in order to activate the startup mode of the fuel cell within a shorter time period; and
the energy-saving mode refers to the mode wherein the electrical power generator lowers fuel cell power restrictions, increases reference values for MEA's impedance and selects fuel cell power output at a higher operating efficiency, in order to activate startup for the fuel cell with less fuel.

24. The fuel cell activation method as claimed in claim 1, wherein the electrical power generator is a direct methanol fuel cell, which is made of a substrate structure.

25. The fuel cell activation method as claimed in claim 1, wherein the fuel processing unit stores fuel required for electrochemical reactions generated by the electrical power generator as well as reaction residuals.

26. The fuel cell activation method as claimed in claim 25, wherein the fuel processing unit further comprises a pump and a plurality of microchannels; the microchannels communicate with the electrical power generator and the pipeline structure of the fuel processing unit, whereas the pump is a microfluidic driving device that drives fluid in the microchannels.

27. The fuel cell activation method as claimed in claim 1, wherein the fan unit is a fan device to assist convection of air between the inside and the outside of the electrical power generator.

28. The fuel cell activation method as claimed in claim 1, wherein the control unit is formed by a chip and circuit means, including a logical judgment means and an information input/output means, in order to control the operations and the procedural control of the pump of the fuel processing unit and the fan unit, and the control unit further comprises a operational recording means of the fuel cell for recording the operational status of the electrical power generator; the operational status having the time information indicative of the most recent operations of the electrical power generator.
